(19) United States
(12) Patent Application Publication
(10) Pub. No.: US 2016/0139872 A1
(43) Pub. Date: May 19, 2016

(54) Method for Controlling Voice Talk of Portable Terminal

(71) Applicants: Young Min Jeoung, Gimpo-si (Gyeonggi-do) (KR); OPENVACS CO., LTD., Seoul (KR)

(72) Inventor: Young Min Jeoung, Gimpo-si (Gyeonggi-do) (KR)

(73) Assignees: Openvacs Co., Ltd., Seoul (KR); Young Min Jeoung, Gimpo-si (Gyeonggi-do) (KR)

(21) Appl. No.: 14/889,949

(22) PCT Filed: May 8, 2014
(86) PCT No.: PCT/KR2014/004059

§ 371 Date: Nov. 9, 2015

(30) Foreign Application Priority Data
May 9, 2013 (KR) 10-2013-0052567

(51) Int. Cl. G06F 3/16; G06F 3/02; G06F 3/0482; G06F 3/0484; H04M 1/725; G06F 3/0488

(52) U.S. Cl. CPC G06F 3/165; H04M 1/72552; G06F 3/04883; G06F 3/0482; G06F 3/04842; G06F 3/0227

(57) ABSTRACT

A generated voice talk file is transmitted when a touchscreen of a sender mobile terminal is touched off to a receiver mobile terminal and the receiver mobile terminal performs the voice talk by reproducing the voice talk file, so that voice call quality is improved and the ‘No signal’ phenomenon, delayed connection, and noise caused by the network state may be minimized. A voice input area occupying the majority of the touchscreen decides a generating and ending time of the voice talk file. The method displays a voice input area on a touchscreen; generates a voice talk file corresponding to a voice signal of a user when the voice input area is touched on; and stops generation of the voice talk file and transmits the voice talk file to a user preset phone number of a receiver mobile terminal when the voice input area is touched off.

### TECHNICAL FIELD

The present invention relates to a method of controlling a portable terminal, and more particularly, to a voice talk-controlling method of a portable terminal of controlling on/off of the voice talk through a touch input and implementing voice talk using cache of generating a voice signal in the form of a file to transmit and streaming voice talk of transmitting the voice signal in real time as a touch input.

### BACKGROUND ART

A mobile terminal or a portable terminal such as a cellular phone, a smartphone, a personal digital assistant (PDA), a tablet personal computer (PC) provides not only voice call service, but also now real-time text message service. Kakao Co., Ltd. Provides the Voice Talk service through which mobile terminal users send and receive voice calls using data networks constructed by mobile communication companies.

The Voice Talk serviced by Kakao Co., Ltd. performs the voice call by transmitting a voice signal to a mobile terminal of a receiver in streaming environment and enables a sender mobile terminal and a receiver mobile terminal to send and receive voice signals to each other using WiFi network, 3G or 4G data network. However, since the voice talk transmits and receives the voice signal using the data network, phenomena such as ‘No signal,’ a delayed connection, noise, and so on may occur. Since call quality may be poor, a user may feel a difficulty to express correct communication. Meanwhile, after the sender's voice is transmitted correctly, Push-to-Talk (PTT) service may be used when to listen to a receiver's voice. In the push-to-talk service, the voice call may be carried out such that a sender mobile terminal transmits a voice signal to the receiver's mobile terminal and that the receiver mobile terminal transmits the voice signal to the sender mobile terminal.

Korean Patent Publication No. 10-2003-0073893 suggests a real time voice information transmission using a wireless instant messenger of exchanging usual text stream and providing voice communication service between multi-users in the form of a walki-talkie using TRS. However, since Korean Patent Publication No. 10-2003-0073893 transmits streaming voice signals using Internet, No signal phenomenon of a voice signal, the delayed connection, and noise may be occurred like the case of the voice talk service provided Kakao Co., Ltd.

### DISCLOSURE

### Technical Problem

The present invention provides a voice talk controlling method of controlling a sender mobile terminal and a receiver mobile terminal transmit voice signals alternately for a voice call, wherein a voice signal is transmitted by touching on and off a touchscreen of the sender mobile terminal and a voice signal of a sender is generated into a file when the touchscreen is touched off and is transmitted to the sender mobile terminal to prevent the voice call quality from being deteriorated caused by network state.

### Technical Solution

The above-mentioned aspects are achieved by providing a method of controlling a voice talk of a mobile terminal including: displaying a voice input area on an area of a touchscreen; generating a voice talk file corresponding to a voice signal of a user when the voice input area is touched on; and stopping the generation of the voice talk file and transmitting the voice talk file to a phone number of a receiver mobile terminal preset by the user when the voice input area is touched off.

Another aspect of the present invention is achieved by providing a method of controlling a voice talk of a mobile terminal including: displaying whole area of a touchscreen as a voice input area; generating a voice talk file corresponding to a voice signal of a user when the voice input area is touched on; stopping the generation of the voice talk file and transmitting the voice talk file to a phone number of a receiver mobile terminal preset by the user when the voice input area is touched off; and responding to an input of a button key which is provided at a position separated from the voice input area and displaying a control menu of the voice input area on a side of the touchscreen after touching an area of the voice input area.

### Advantageous Effects

According to the present invention, a voice talk file generated when a touchscreen of a sender mobile terminal is touched off is transmitted to a receiver mobile terminal and the receiver mobile terminal performs the voice talk by reproducing the voice talk file, so that voice call quality is improved and that ‘No signal’ phenomenon, delayed connection, and noise caused by the network state may be minimized. Moreover, according to the present invention, a voice input area the majority of the touchscreen of a mobile terminal is used to decide a generating time and an ending time of the voice talk file, so that user convenience may be enhanced.

### DESCRIPTION OF DRAWINGS

FIG. 1 is a schematic view illustrating a whole system for implementing a voice talk controlling method according an embodiment of the present invention;

FIG. 2 is a schematic view illustrating an interface of a driven App according to an embodiment of the present invention;

FIG. 3 is a flowchart illustrating the voice talk controlling method of a mobile terminal according to an embodiment of the present invention;

FIGS. 4 to 6 are reference view illustrating the voice talk controlling method of a mobile terminal according to an embodiment of the present invention;

FIG. 7 is an interface of a driven App according to an embodiment of the present invention; and

FIGS. 8 and 9 are reference view illustrating the voice talk controlling method of a mobile terminal according to another embodiment of the present invention.

### BEST MODE

A portable terminal or a mobile terminal may be referred to a device enabling a voice communication and data communication and having a touchscreen, such as a mobile phone, a smartphone, a laptop computer, a tablet computer, a personal digital assistant (PDA), etc., and any device of enabling the voice communication and data communication and having a touchscreen may be referred to the mobile terminal or the portable terminal.

In this application, the mobile terminal is classified into a sender mobile terminal and a receiver mobile terminal. However, the sender mobile terminal and the receiver mobile terminal are only classified according to which side transmits the voice talk and the roles of the sender mobile terminal and the receiver mobile terminal may be switched to each other.

In this application, an App may be a computer program installed and driven in a mobile terminal, usually in a smartphone.

A voice talk controlling method of a mobile terminal may be performed by an App installed in a mobile terminal, a system program installed in a mobile terminal, or a computer program installed in a terminal such as a personal computer. Moreover, the voice talk file may be transmitted, received, and reproduced by a different communication program including a program module provided by a same software development kit (SDK). In this application, the method of controlling voice talk using an App installed in a mobile terminal will be described, but by only the App and the present invention is not limited to the App.

The present invention will be described in detail with reference with the accompanying drawings.

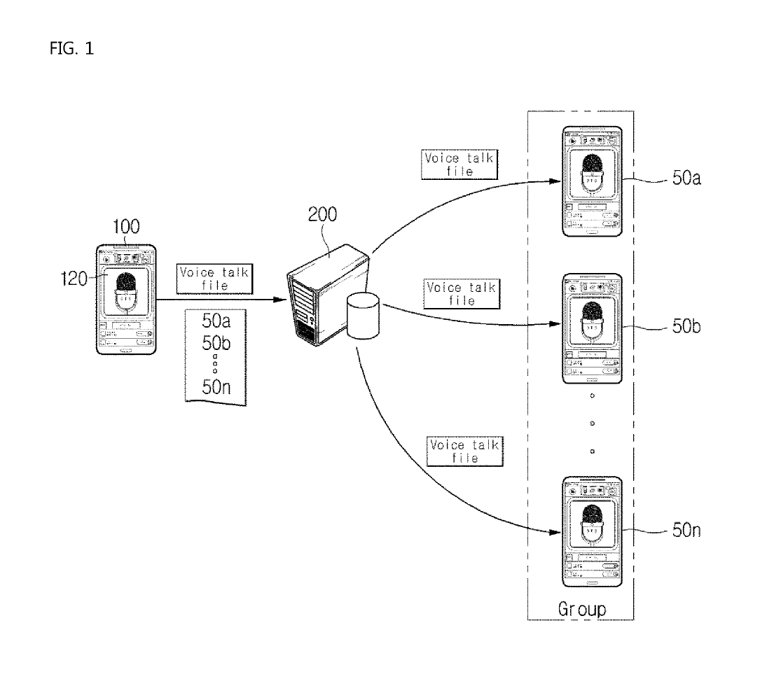

FIG. 1 is a schematic view illustrating a whole system for implementing a voice talk controlling method according an embodiment of the present invention.

Referring to FIG. 1, in a voice talk controlling method according to an embodiment of the present invention, a sender mobile terminal 100 connected to a wireless network transmits a voice talk file to receiver mobile terminals 50a to 50n through a voice talk server 200 being developed by this applicant and the receiver mobile terminals 50a to 50n may receive and reproduce the voice talk file transmitted from the sender mobile terminal 100.

Here, the same App must be installed in the sender mobile terminal 100 and the receiver mobile terminals 50a to 50b. The App installed in the sender mobile terminal 100 and the receiver mobile terminals 50a to 50n may perform the following functions:

1) Being connected to the voice talk server 200 via a wireless network when the App is driven;

2) Displaying a voice input area on a screen when an icon corresponding to the App is selected by users on touchscreens provided to the mobile terminals 100 and 50a to 50n;

3) Displaying an address at a position included to or neighboring to the voice input area to select a receiver;

4) Displaying a mode-switching menu at a position included to or neighboring to the voice input area to switch a voice talk mode and a text message mode;

5) Determining whether a touch is inputted in the voice input area;

6) Generating a digital voice signal in a preset format corresponding to voice when user's voice is inputted while the touch input is applied on the voice input area; and

7) Finishing the voice signal generation and transmitting to any one of the receiver mobile terminals 50a to 50n where a user is preset via a wireless network when the touch input is released from the voice input area.

On the other hand, the computer program of transmitting and receiving the voice talk between the sender mobile terminal and the receiver mobile terminals is called “App” in this application. However, “the voice talk controlling method of a mobile terminal” according to the present invention transmits and receives the voice talk file not only between mobile terminals but also between a mobile terminal and a personal computer or between a mobile terminal and other device.

Thus, a PC version of the “App” may be generated and distributed such that the voice talk file may be transmitted and received by a program having the same function as the App and not installed in a mobile terminal.

On the other hand, even when the same App or program (or system program) is not installed in the sender mobile terminal 100 and the receiver mobile terminals 50a to 50n, the voice talk file may be transmitted and received according to an embodiment of the present invention.

Now, the App and the program provide a modulized program tool by a program provider, called a software development kit (SDK). The SDK includes program modules by functions, so that a developer combines a plurality of the modules or modifies some of the program modules for the development of a desired program. Thus, if there is a program including program modules having the above-mentioned functions 1) to 7), the sender mobile terminal 100 and the receive mobile terminals 50a to 50n may transmit and receive the voice talk file to and from each other and reproduce the received voice talk file even when the same App or program (or system program) is not installed in the sender mobile terminal 100 and the receiver mobile terminals 50a to 50n.

When the program including the functions as listed in 1) to 7) is provided to and installed in a personal computer, a user of the personal computer and the users of the mobile terminals 50a to 50n and 100 may perform the voice call while transmitting and receiving the voice talk file to and from each other. To this end, a program installed and driven in a personal computer and to execute the functions 1) to 7) may be provided to the personal computer, and may be developed and distributed by the present applicant. Thus, the term call “App” in this application may indicate not only a program installed in the mobile terminal but a program installed in a personal computer.

The sender mobile terminal 100 in which the App is installed drives the App (or a module, hereinafter, will be omitted), the receiver mobile terminals 50a to 50n display voice input areas, wherein the voice input area occupies a maximized zone of the touchscreens. For example, the voice input area may be the entire, a half, or ¾ of displaying area of the touchscreen, because the voice input area occupies a large area as wide as possible on the touchscreen so that a user of the sender mobile terminal 100 may easily touch on or off the voice input area.

When the voice input area is the entire of the displaying area of the touchscreen, the user of the sender mobile terminal 100 generates voice to be transmitted to the receive mobile terminals 50a to 50n without looking at menus on the touchscreen in detail but rough touch on the touchscreen and touches off the touchscreen, the App installed in the mobile terminal 100 may finish the generation of the voice talk file and transmit the voice talk file of the voice generated until the touch-off to the receiver mobile terminals 50a to 50n.

In this case, the voice talk file is a voice file generated from the sender mobile terminal 100 such as a file in various formats or in a format developed by this applicant. The voice talk file is a digital voice file generated by recording analog voice inputted to the sender mobile terminal 100, is generated when the touchscreen is touched on, and the generation of the voice talk file is finished when the touchscreen is touched off.

The sender mobile terminal 100 may transmit the voice talk file to one or all of the receiver mobile terminals 50a to 50n.

When a user of the sender mobile terminal 100 selects one of the receiver mobile terminals 50a to 50n from address, the voice talk file is transmitted to a corresponding receiver mobile terminal 50a to 50n. On the contrary, when the user of the sender mobile terminal 100 selects all receiver mobile terminal 50a to 50n from the address to transmit the voice talk file, the voice talk file is transmitted to the voice talk server 200 such that the voice talk server 200 may transmit the voice talk file transmitted from the sender mobile terminal 100 to all receiver mobile terminals 50a to 50n.

In this case, the receiver mobile terminals 50a to 50n reproduce the voice talk file in real time as soon as the voice talk file is received from the voice talk server 200, after the voice talk file is completely received from the voice talk server 200 or from when some (for example, 10%) of the voice talk file is received from the voice talk server 200. However, the present invention is not limited thereto.

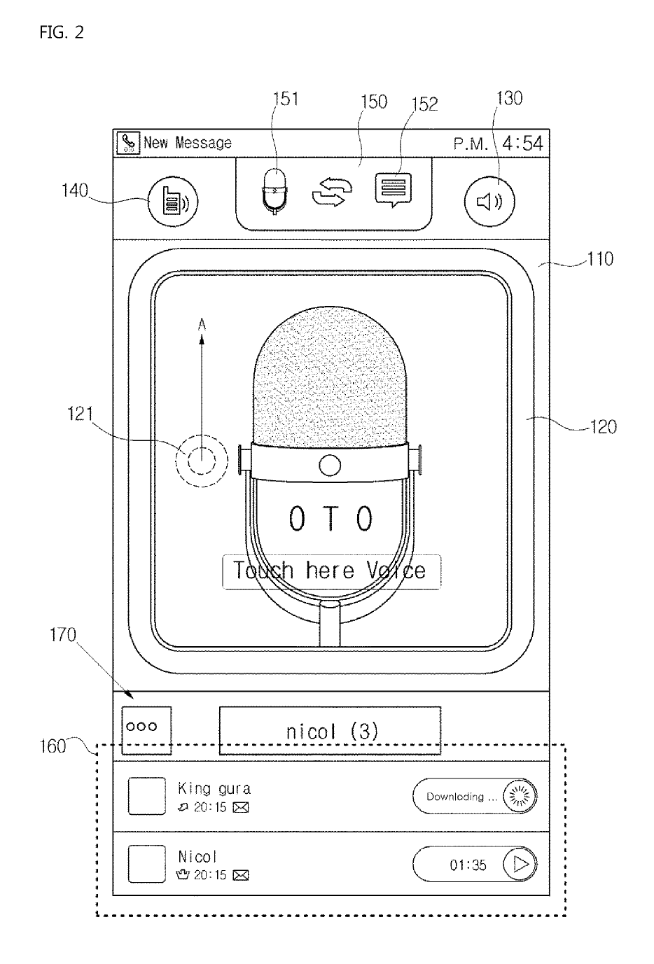

FIG. 2 is a schematic view illustrating an interface of a driven App according to an embodiment of the present invention.

Referring to FIG. 2, the interface according to an embodiment of the present invention may include a voice input area 120, a speaker On-Off menu 130, a real time reproducing menu 140, a mode switching menu 150, a voicemail box menu 160, and an unfolding menu 170.

The voice input area 120 is a menu occupying the widest area on the touchscreen 110 and may be ½ to ¾ of the touch area of the touchscreen 110. Otherwise, icons of some menus are listed at a side of the touchscreen 110 and the majority of a touch area may be set to the voice input area 120. The App may record user's voice when a touch input is generated on the voice input area 120 and finish the recording of the user's voice when the user touches off.

Meanwhile, the App may stop generating the voice talk file when a user drags from a position 121 where the user early touched in the voice input area 120 in the direction A. When a drag input is generated in an area A or in the direction opposite to the area A, the App may not generate the voice talk file even when the voice input area 120 is touched.

A reference numeral “130” indicates a speaker on-off menu of setting whether the receiver mobile terminals 50a to 50n may reproduce the voice talk file through speakers (not shown) provided to the receiver mobile terminals 50a to 50n or to earphones (or headphones) connected to the receiver mobile terminals 50a to 50n.

A reference numeral “140” indicates an automatic play menu in which the voice talk file transmitted from the sender mobile terminal 100 to the receiver mobile terminals 50a to 50n is automatically played in real time.

Here, the receiver mobile terminals 50a to 50n, when the App is driven, may reproduce the voice talk file transmitted from the sender mobile terminal in real time. On the contrary, if the App installed in the receiver mobile terminals 50a to 50n is not driven, when the receiver mobile terminals 50a to 50n receive the voice talk file, an alarm message for noticing the arrival of the voice talk file to users may be displayed on the receiver mobile terminals. In this case, the users of the receiver mobile terminals 50a to 50n must touch and confirm the alarm message displayed on the touchscreens 110 and reproduce the voice talk file using a specific reproducing program. That is, in this case, the receiver mobile terminals 50a to 50n can receive and reproduce the voice talk file, while, for the transmission of the voice talk file from the receiver mobile terminals 50a to 50n to the sender mobile terminal 100, an App for transmitting and receiving the voice talk file must be driven. In this case, the alarm message transmitted to the receiver mobile terminals 50a to 50n may be a push message provided from the voice talk server 200.

A reference numeral “150” indicates a mode-switching menu for switching a voice talk mode and a text message mode, while reference numerals “151” and “152” indicate icons corresponding to the voice talk mode and the text message mode, respectively.

A reference numeral “160” is a voicemail box menu to display the voice talk file that is transmitted and received between the sender mobile terminal 100 and the receiver mobile terminals 50a to 50n. The voicemail box menu is registered to the receiver mobile terminals 50a to 50n and may be called by users and reproduced in the receiver mobile terminals 50a to 50n.

A reference numeral “170” is an unfold menu in which a receiver group setting menu for setting a receiver group with whom the user has a conversation may be displayed on the touchscreen 110 when the unfold menu is touched by a user.

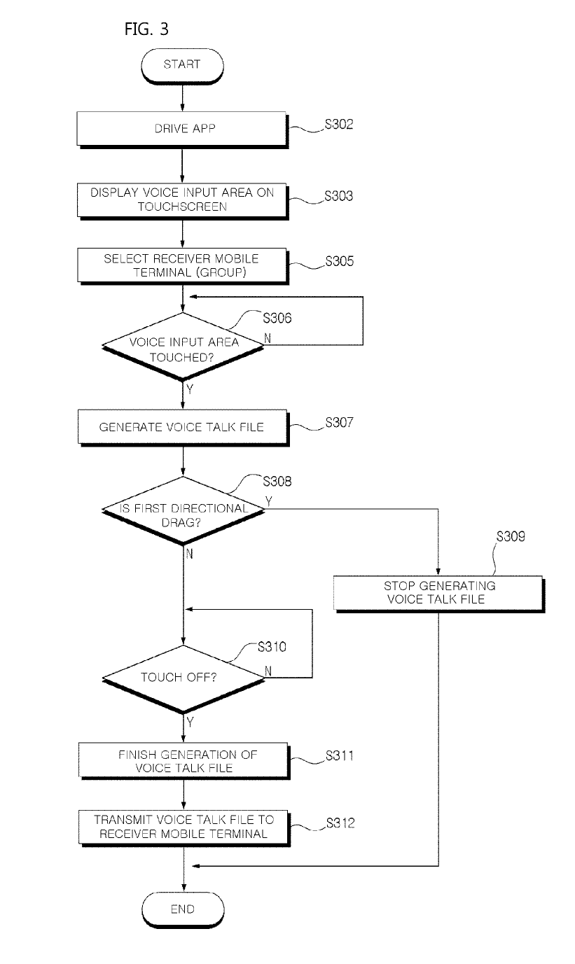

FIG. 3 is a flowchart illustrating the voice talk controlling method of a mobile terminal according to an embodiment of the present invention.

Referring to FIG. 3, in the voice talk controlling method of a mobile terminal according to an embodiment of the present invention, firstly, a user of the sender mobile terminal 100 drives an App installed in the sender mobile terminal 100 (S302). At this time, the App displays the voice input area 120 on the touchscreen 110 of the sender mobile terminal 100. In this case, an area of the voice input area displayed on the touchscreen 110 may be ½ to ¾ of a displaying area of the touchscreen 110 provided in the sender mobile terminal 100. By the area allocation, the user of the sender mobile terminal 100 roughly touches the central region of the touchscreen 110 instead of touching a specific menu or an icon that are displayed on the touchscreen 110 to generate a voice talk file.

Next, the App may receive a user's choice with respect to the receiver mobile terminals 50a to 50n to perform the voice talk or the sender mobile terminal and a group (receiver group) to perform the voice talk (S305).

Next, the App determines whether a user's touch is generated on the voice input area 120 displayed on the touchscreen 110 of the sender mobile terminal 100 (S306). At this time, the App generates a voice talk file during keeping the touch input after the user's touch is generated on the voice input area 110 (S307).

Next, the App determines whether a drag input is generated while the user's touch input is applied to the touchscreen 110 of the sender mobile terminal (S308).

The App may stop generating the voice talk file when a drag input is applied in a first direction or in a second direction having a phase different of 180 degrees with respect to the first direction after the touch input on the touchscreen 110. Here, the first direction may be the direction A described with reference to FIG. 2 or a direction perpendicular to the direction A. Here, the App may stop generating the voice talk file when a drag input is applied in the first direction or in the second direction having a phase difference of 180 degrees from the first direction after the touch input is applied to the touchscreen 110 (S309).

Next, the App determines whether a user's touch-off is generated from the touchscreen 110 of the sender mobile terminal (S310). When the touch-off is generated, the App stops generating the voice talk file from the sender mobile terminal 100 (S311) and transmits the voice talk file generated until the time point where the touch-off is generated to the receiver mobile terminals 50a to 50n (S312). In this case, since the voice talk file transmitted to the receiver mobile terminals 50a to 50b is not streaming data but a single completed file, when the receiver mobile terminals 50a to 50n receive the voice talk file, a stable quality of reproduced sound may be provided regardless of a network state between the sender mobile terminal 100 and the receiver mobile terminals 50a to 50n.

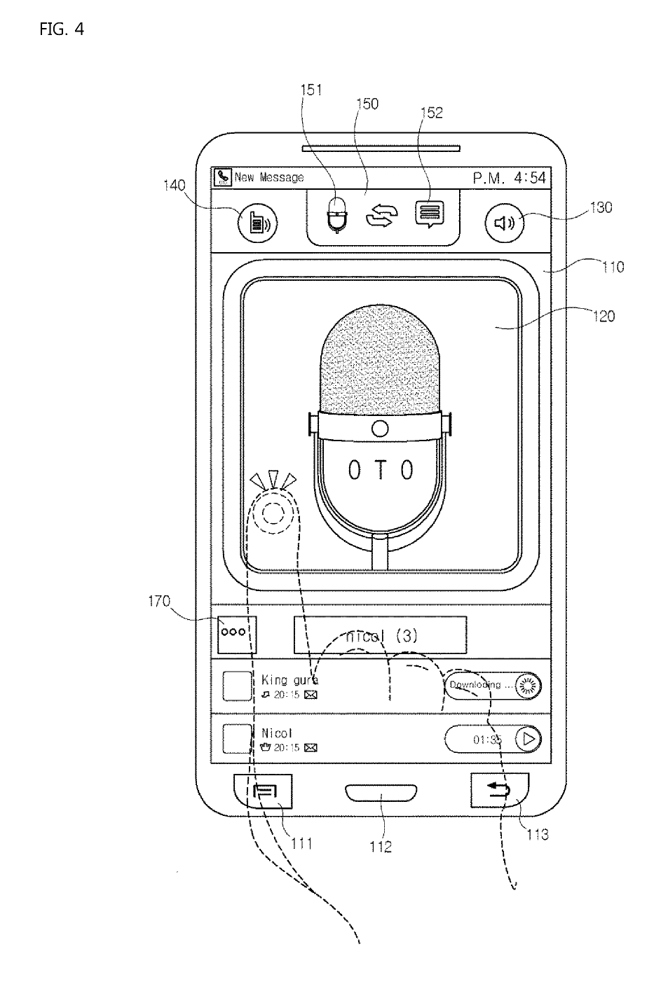

FIGS. 4 to 6 are reference view illustrating the voice talk controlling method of a mobile terminal according to an embodiment of the present invention.

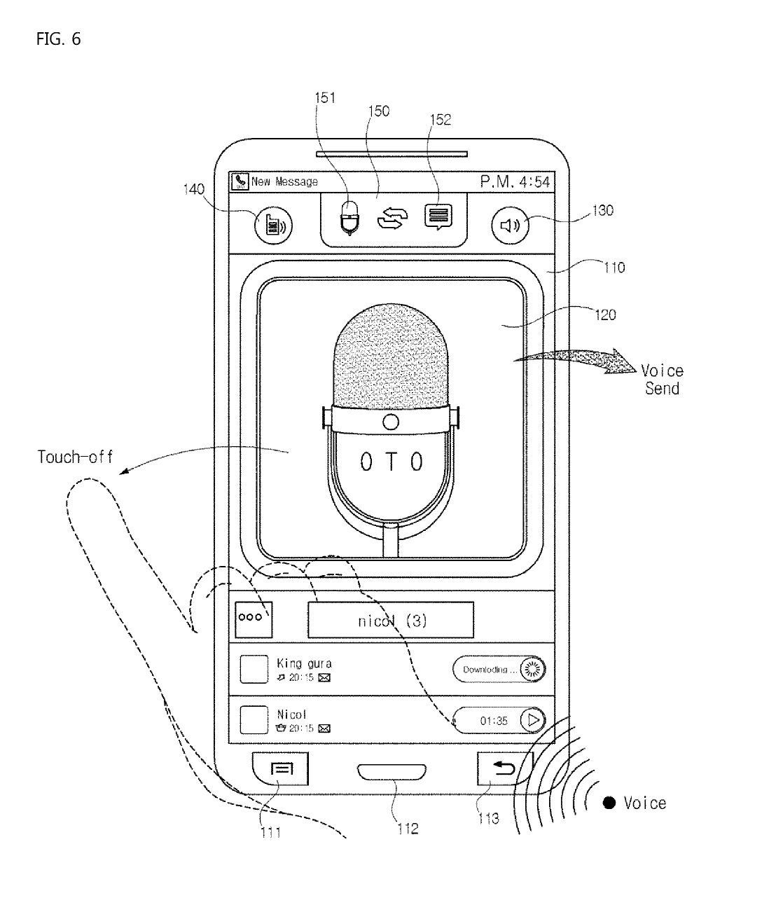

Referring to FIGS. 4 and 6, firstly a user of the sender mobile terminal 100 applies the touch input to the voice input area 120 and does not touch-off while applying the touch input.

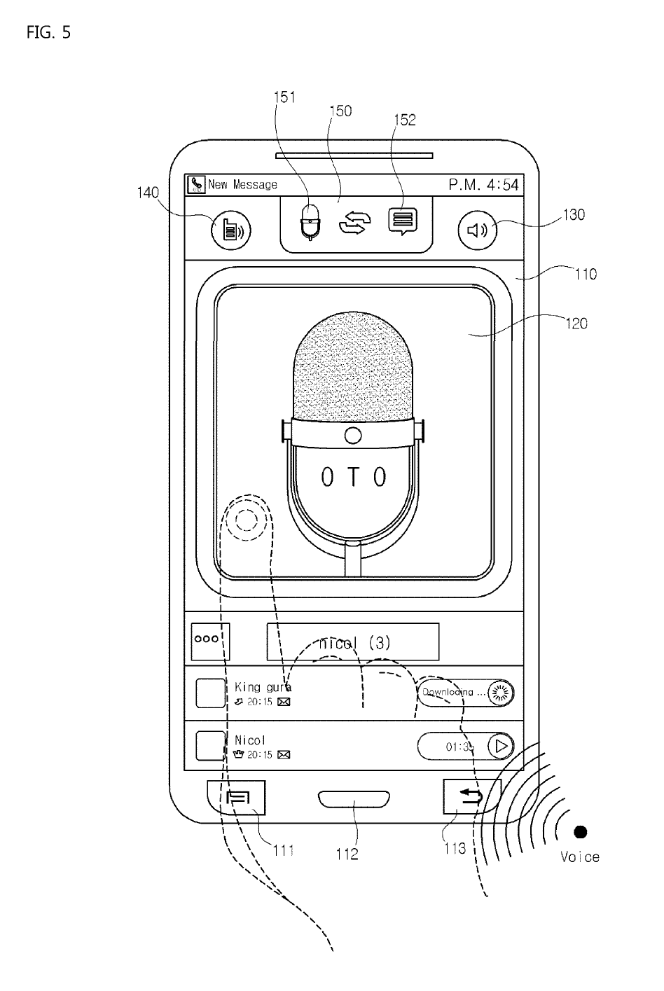

Next, referring to FIG. 5, the user of the sender mobile terminal 100 keeps applying the touch input to the voice input area 120, speaks voice to be transmitted to the receiver mobile terminals 50a to 50n while applying the touch input to the voice input area 120, and a microphone provided to the sender mobile terminal 100 records the user's voice to generate a digital voice file of which a voice signal generated at this time corresponds to the voice talk file.

Next, referring to FIG. 6, when the user of the sender mobile terminal 100 touches off the voice input area 120, the App finishes the generation of the voice talk file from the sender mobile terminal 100. The App may generate the voice talk file from when the touch input is applied to the voice input area 120 until the touch input applied to the voice input area 120 is released. The voice talk file generated until the user of the sender mobile terminal 100 touches off the voice input area 120 is transmitted to the voice talk server 200, and the voice talk server 200 transmits the voice talk file transmitted from the sender mobile terminal 100 to a receiver (or a receiver group) set by the sender mobile terminal 100. By doing so, even when WiFi network, 3G network, and 4G network are unstable, since the sender mobile terminal 100 and the receiver mobile terminals 50a to 50n transmit and receive the voice signals to and from each other during the communication of files (voice talk file), delay of the voice talk file may happen but quality of a call is not deteriorated.

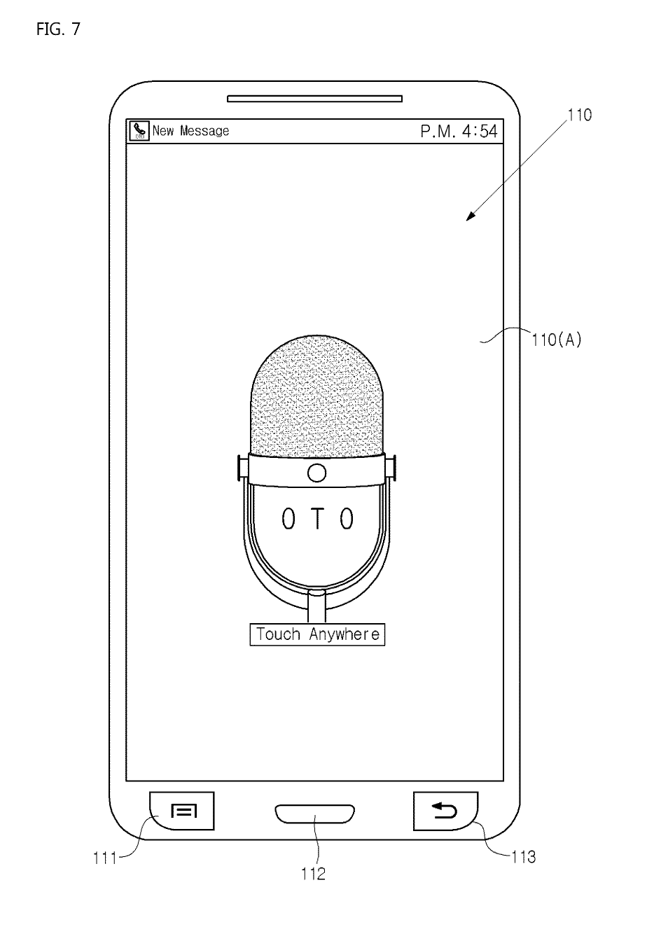

FIG. 7 is an interface of a driven App according to an embodiment of the present invention.

Referring to FIG. 7, the interface according to the embodiment of the present invention is displayed on the touchscreen 110 and whole touch region of the touchscreen 110 corresponds to the voice input area. Thus, in this embodiment, the touchscreen and the voice input area are indicated by reference numerals “110” and “110-A.”

The voice input area 110-A is formed throughout entire touchable area of the touchscreen 110. Thus, the interface as shown in FIG. 7 generates a voice talk file by recording user's voice when a user touches the touch input area and stops the voice recording when the touch input of the user is finished, and transmits the voice talk file of the user's voice recorded until that time to the receiver mobile terminals 50a to 50n.

Here, since the voice input area 110-A is formed throughout the whole area of the touchscreen 110, the user may touch any area of the touchscreen 110 to generate the voice talk file, and this means that the user does not need to select or inquire a menu for generating the voice talk file from the touchscreen 110.

In order to use the voice talk service, a user touches any area of the touchscreen 110. When the user speaks desired voice while maintaining the touch input, the App may generate a digital voice signal for the user's voice and the voice talk file.

If there is a small menu in an area of the touchscreen 110 to use the voice talk service, it is inconvenient for the user to seek the corresponding menu and to select a menu by estimating a touch area of the corresponding menu. In this embodiment, since whole touch area of the touchscreen 110 is set as the voice input area, these inconveniences cannot happen.

Meanwhile, since the entire touchscreen 110 is set as the voice input area, there may occur problems such as menus required to use the voice talk service cannot be displayed on the touchscreen 110 and the generation of the voice talk file cannot be canceled. With respect to these problems, this applicant proposes a way of displaying menus relating to the voice talk service on the touchscreen 110 using button keys 111, 112, and 113 and of stopping the generation of the voice talk file using a pattern touch.

A button key of the button keys indicated by a reference numeral “111” corresponds to a menu button, a button indicated by a reference numeral “112” corresponds to a home button, and a button key indicated by a reference numeral “113” corresponds to a cancel key. The button keys 111, 112, and 113 may be mechanical button or a touch button. In the touch button, the button keys 111, 112, and 113 do not have a function of displaying an image different from the touchscreen 110.

When a control menu is displayed on the touchscreen 110 within the voice input area 110-A as shown in FIG. 7, when a user selects the menu button 111, control menus for the reference numerals 130, 140, 150, 160, and 170 as illustrated in FIG. 2 may be displayed on the touchscreen 110. The control menus 130, 140, 150, 160, and 170 (See FIG. 2) may be arranged at the upper or lower side of the touchscreen 110 as shown in FIG. 7, or identically as shown in FIG. 2.

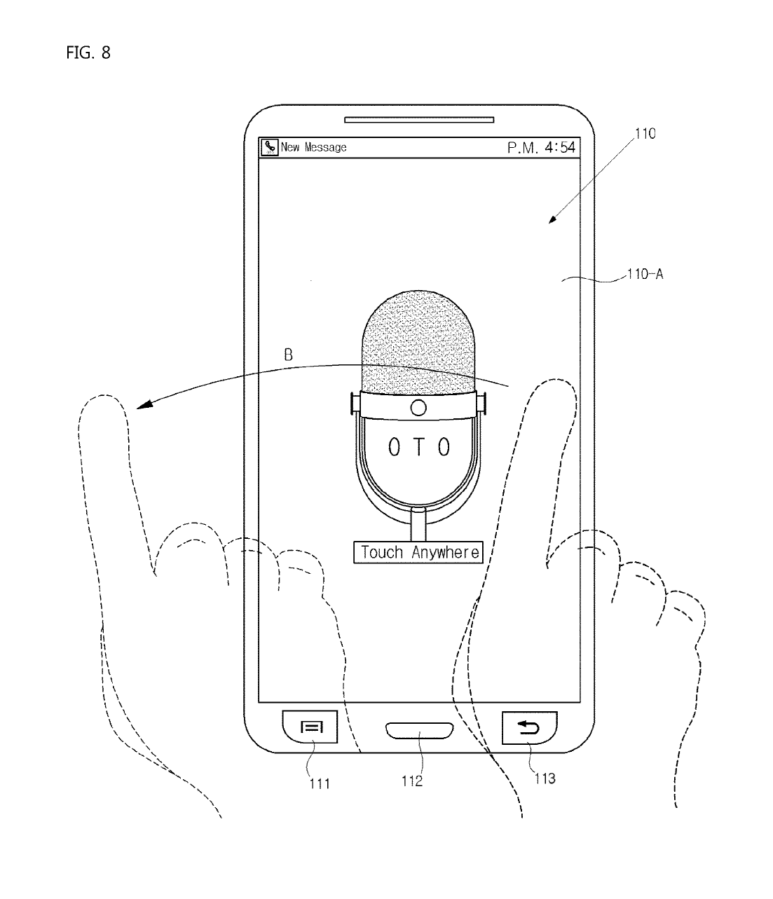

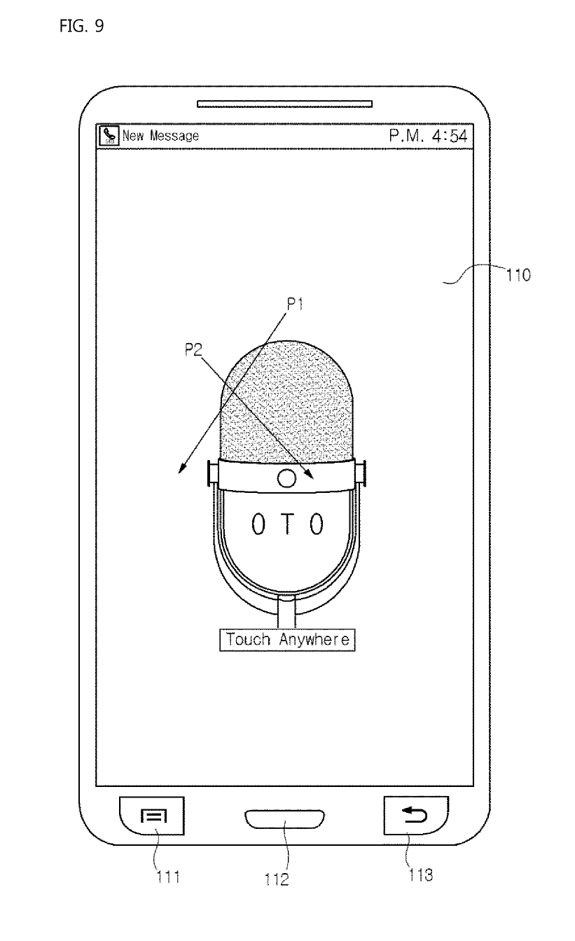

FIGS. 8 and 9 are reference view illustrating the voice talk controlling method of a mobile terminal according to another embodiment of the present invention.

First, FIG. 8 shows a reference view of an example of stopping a voice talk file for the user's voice through the pattern touch input on the voice input area 110-A.

As illustrated in FIG. 8, in a case when a user touches the touchscreen 110 to generate a voice talk file for the user's voice, if the user wants to cancel the generation of the voice talk file, the user may cancel the generation of the voice talk file by applying a drag input in a direction “B” while touching the touchscreen 110. The user applied the drag input in the direction “B” on the touchscreen 110 such that the undesired voice talk file is not transmitted to the receiver mobile terminals 50a to 50n.

Next, FIG. 9 is a reference view illustrating another example of a pattern input stopping generation of a voice talk file according to another embodiment of the present invention.

Referring to FIG. 9, when a user touches the touchscreen 110 and applies a drag input according to a pattern in the order of P1 to P2, the App installed in the sender mobile terminal 100 defers the transmission of the voice talk file when the drag input P1 is inputted to the touchscreen 110 and may cancel transmission of the deferred voice talk file when an additional drag input P2 forms an X-shape with the previously inputted drag input P1. The drag input with the above-mentioned patter is available even when being inputted in any area of the touchscreen 100.

1. A method of controlling a voice talk of a mobile terminal comprising:
displaying a voice input area on an area of a touchscreen;
generating a voice talk file corresponding to a voice signal of a user when the voice input area is touched on; and
stopping the generation of the voice talk file and transmitting the voice talk file to a phone number of a receiver mobile terminal preset by the user when the voice input area is touched off.

2. The method as claimed in claim 1, further comprising canceling, performed after the generation of the voice talk file, the generation of the voice talk file when a drag input occurs in a first direction in the voice input area.

3. The method as claimed in claim 1, wherein, in the transmission of the voice talk file, the voice talk file is transmitted with reference to any one of address and a conversation group of the receiver mobile terminal preset by the user.

4. The method as claimed in claim 1, wherein, in the display of the voice input area, a mode-switching menu for switching a voice talk mode for the transmission of the voice talk file and a text message mode is displayed neighbored to the voice input area.

5. The method as claimed in claim 4, further comprising displaying a text message transmission and reception menu instead of the voice input area displayed on the touchscreen when the text message mode is selected by the user through the mode-switching menu.

6. The method as claimed in claim 1, wherein
the phone number of the receiver mobile terminal comprises plural phone numbers;
wherein the transmission of the voice talk file comprises transmitting the voice talk file to the plurality of the phone numbers of the receiver mobile terminal.

7. The method as claimed in claim 1, wherein the voice input area corresponds to whole displaying area of the touchscreen.

8. The method as claimed in claim 7, wherein the voice input area displays a mode-switching menu for switching a mode to a text message mode on a side.

9. The method as claimed in claim 7, wherein the voice input area further comprises an address displaying menu for selecting a phone number of the receiver mobile terminal.

10. The method as claimed in claim 7, wherein the voice input area further comprises a real time reproducing menu for reproducing a voice signal received from the receiver mobile terminal in an area in real time.

11. The method as claimed in claim 1, wherein the voice input area corresponds to ½ to ¾ of a touch area of the touchscreen.

12. A method of controlling a voice talk of a mobile terminal comprising:
displaying whole area of a touchscreen as a voice input area;
generating a voice talk file corresponding to a voice signal of a user when the voice input area is touched on;
stopping the generation of the voice talk file and transmitting the voice talk file to a phone number of a receiver mobile terminal preset by the user when the voice input area is touched off; and
responding to an input of a button key which is provided at a position separated from the voice input area and displaying a control menu of the voice input area on a side of the touchscreen after touching an area of the voice input area.

13. The method as claimed in claim 12, wherein the button is at least one of a cancel button, a home button, and a menu button.

14. The method as claimed in claim 13, wherein the displaying of the control menu on the side of the touchscreen further comprises responding to a button input for one another of the cancel button, the home button, and the menu button and returning a main menu on the touchscreen of the mobile terminal.

15. The method as claimed in claim 12, further comprising stopping the generation of the voice talk fil when a drag input occurs on the touchscreen according to a first pattern.
